(19) United States
(12) Patent Application Publication
(10) Pub. No.: US 2022/0250679 A1
(43) Pub. Date: Aug. 11, 2022

(54) METHOD FOR CONTROLLING A STEER-BY-WIRE STEERING SYSTEM AND STEER-BY-WIRE STEERING SYSTEM FOR A MOTOR VEHICLE

(71) Applicants: thyssenkrupp Presta AG, Eschen (LI); thyssenkrupp AG, Essen (DE)

(72) Inventors: Peter KAKAS, Budapest (HU); Àdám VARGA, Budapest (HU); Daniel VIZER, Csabdi (HU)

(73) Assignees: thyssenkrupp Presta AG, Eschen (LI); thyssenkrupp AG, Essen (DE)

(21) Appl. No.: 17/435,907

(22) PCT Filed: Mar. 2, 2020
(86) PCT No.: PCT/EP2020/055451

§ 371 Date: Sep. 2, 2021

(30) Foreign Application Priority Data
Mar. 6, 2019 (DE) 10 2019 203 039.4

(51) Int. Cl. B62D 6/00; B62D 5/04

(52) U.S. Cl. CPC B62D 6/008; B62D 5/0463

(57) ABSTRACT

A method for controlling a steer-by-wire steering system involves determining a torque request signal with a position controller based on desired and actual steering angles, checking with a checking device for an error state of the position controller, selecting the torque request signal as a checked torque request signal if the error state has not been determined, selecting a reference torque signal as the checked torque request signal if the error state has been determined, and transmitting the checked torque request signal to the steering actuator. By evaluating a cumulative deviation variable, which is calculated by a calculation unit of the checking device as a time integral over a control deviation between the desired and actual steering angles, the checking device determines whether the error state is present and determines the reference torque signal with a reference controller based on the control deviation.

### DESCRIPTION

The invention relates to a method for controlling a steer-by-wire steering system according to the preamble of claim 1 and to a steer-by-wire steering system for a motor vehicle according to the preamble of claim 10.

In steer-by-wire steering systems for motor vehicles, there is no longer a mechanical connection between a steering wheel operated by the driver and the steered wheels. Instead, the position of the steered wheels is adjusted by an electronically controlled steering actuator in order to guide the vehicle on the desired path. For this purpose, a feedback actuator connected to the steering column provides a desired position signal that represents the driver's steering intention. The steering actuator is then activated with a torque request signal via a position controller with sufficient power and bandwidth in such a way that the steered wheels are adjusted to the desired position.

This safety-critical control task has to ensure a high level of failure safety so that the vehicle, despite not having the mechanical connection, remains steerable even in the event of a defective position controller and the driver retains control of the vehicle. For this reason it is important to develop safety concepts for the control loop of the steering actuator.

A method for attenuating irregularities in a first control command for controlling a power steering system of a vehicle is known from U.S. Pat. No. 9,598,102 B2. The method generates a range signal indicative of a range of command values on the basis of a multiplicity of input signals and determines whether the first control command is out of range for more than a predetermined amount of time. A second control command is generated on the basis of a subset of the multiplicity of input signals and sent to the power steering system in response to it being determined that the first control command is out of range for more than the predetermined amount of time. It is disadvantageous that the previously known method only insufficiently takes into account the driving situation in which the motor vehicle is located, and therefore the generated range signal has to be equally applicable to a large number of different driving situations, such as cornering and straight-ahead driving. Furthermore, it is not taken into account which lane deviations cause erroneous first control commands before the specified range is left. This means that incorrect control commands due to major irregularities can only be recognized late.

U.S. Pat. No. 8,660,754 B2 describes a steering system for a vehicle in which the steering speed is determined based on the sum of a steering wheel speed signal and a correction signal. The correction signal depends on the angle error between the steering wheel position and the position of a steered element, said angle error being increased or decreased depending on the steering wheel speed. This ensures that steering wheel speeds below a certain threshold value do not lead to any correction of the angle error and the risk of dangerous situations in the event of failure of a position sensor of the steered element is reduced. It is disadvantageous that the angle error remains uncorrected for an arbitrary length of time with an unchanged steering wheel position, especially when driving straight ahead.

The object of the invention is therefore to specify a method for controlling a steer-by-wire steering system and a steer-by-wire steering system for a motor vehicle, by means of which the safety and reliability of the steering are improved.

This object is achieved by a method for controlling a steer-by-wire steering system having the features of claim 1, and by a steer-by-wire steering system for a motor vehicle having the features of claim 10.

Control of a steer-by-wire steering system is thereby produced, enabling improved error detection and error correction in the event of steering angle deviations. In particular, slight but persistent steering angle deviations between the steering wheel and the steered wheels are reliably corrected. For this purpose, the method according to the invention provides for the calculation of a cumulative deviation variable as a time integral over the control deviation of the position controller in combination with a reference controller designed redundantly to the position controller. Depending on the value of the cumulative deviation variable, the torque request signal specified by the position controller for activating the steering actuator is replaced by a safe reference torque signal determined by the reference controller. The reference torque is suitable for adjusting the desired steering angle of the steering actuator with a tolerable control deviation. At the same time, the reference torque is safe in the sense that it does not cause any sudden or unforeseen changes in the vehicle state and the vehicle remains controllable. The method according to the invention also compensates for slight systematic steering angle errors. The steering system is therefore particularly suitable also for use in at least partially autonomous motor vehicles in which steering angle errors can no longer be compensated for manually by the driver.

The cumulative deviation variable is preferably calculated by weighting the control deviation of the position controller with a driving speed of the vehicle. By weighting the control deviation with the driving speed in the time integral, the effect of the control deviation on the lane of the motor vehicle can be taken into account in the respective driving situation. An equally large control deviation thus leads to an increased cumulative deviation variable due to the weighting at higher speeds. The reference controller therefore intervenes earlier at higher speeds in order to limit the resulting lane deviation. The weighting with the driving speed consequently enables continuous lane deviation monitoring.

The error state of the position controller can be determined by the fact that the cumulative deviation variable exceeds a selectable threshold value. The tolerance of the error monitoring can be set by selecting the threshold value. With a higher threshold value, for example, steering interventions by other assistance systems, such as active steering systems, can also be tolerated. In particular, the threshold value can be selected depending on the driving speed of the vehicle. As a result, corrective steering functions of an active steering can be tolerated in a speed-adjusted manner.

The momentary angular velocity of the steering actuator is preferably taken into account when determining the reference torque signal. As a result, the reference controller can react more quickly to a changing actual steering angle due to external influences, such as contact with the curb.

The reference torque signal preferably contains a component proportional to the control deviation between desired and actual steering angle and a component dependent on the angular velocity of the steering actuator. The reference controller can thus be designed as a PD controller which avoids or at least reduces overshoots in the control. In particular, it can be provided that the reference controller is adapted in an optimized manner to reduce the control deviation.

The selection device can preferably interpolate the checked torque request signal between the reference torque signal and the torque request signal during the switching operations. This avoids a sudden change in the steering actuator torque due to the intervention of the reference controller.

Further refinements of the invention can be gathered from the following description and the dependent claims.

The invention is explained in more detail below with reference to the exemplary embodiment shown in the accompanying figures.

FIG. 1 schematically shows the structure of a steer-by-wire steering system according to an embodiment of the invention,

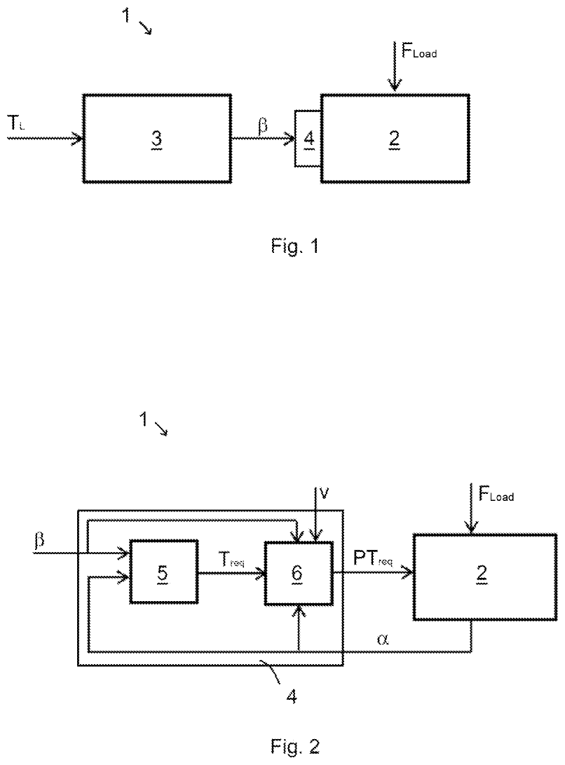

FIG. 2 schematically shows the structure of the activation unit according to the exemplary embodiment according to FIG. 1,

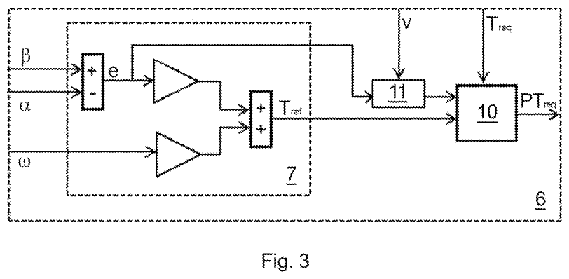

FIG. 3 schematically shows the structure of the checking device according to the exemplary embodiment according to FIGS. 1 and 2.

In FIG. 1, the structure of a steer-by-wire steering system for a motor vehicle according to an embodiment of the invention is illustrated schematically. The steer-by-wire steering system 1 has an electronically controllable steering actuator 2 which acts on steered wheels and which detects an actual steering angle a of the steered wheels (see FIG. 2), and a feedback actuator 3 which detects a desired steering angle β set via a steering wheel. Furthermore, an activation unit 4 is provided which activates the steering actuator 2 in accordance with the desired steering angle β and the actual steering angle a with a checked torque request signal PT_{req}.

The feedback actuator 3 is acted upon by the driver by means of a steering torque T_{L.} as an input variable exerted on a steering wheel. The feedback actuator 3 can be designed to measure the adjustment of the steering wheel brought about by the steering torque T_{L} by means of a rotation angle sensor and to assign a desired steering angle β to the measured angle. Alternatively, the feedback actuator can measure the steering torque T_{L} and can assign a desired steering angle β thereto. The desired steering angle β is transmitted to the activation unit 4 as an output signal of the feedback actuator 3. The activation unit 4 can be part of the steering actuator 2 as an integrated control device or it can be designed as a separate control device. A steering load F_{load} acts on the steering actuator 2 from the steered wheels and counteracts an adjustment of the actual steering angle α by the steering actuator 2 and/or subjects the actual steering angle α to different malfunctions depending on the driving situation. Such external steering loads can be caused, for example, by restoring forces in the straight-ahead position when cornering or by forces due to cross winds.

The structure according to the invention and the mode of operation of the activation unit 4 are explained in more detail with reference to FIGS. 2 and 3. The activation unit 4 has a position controller 5 and a checking device 6, the checking device 6 containing a reference controller 7, a calculation unit 11 and a selection device 10 (cf. FIG. 3).

The activation unit 4 carries out the following method to control the steer-by-wire steering system 1.

The position controller 5 of the activation unit 4 determines a torque request signal T_{req} based at least on the desired steering angle β and the actual steering angle α. The torque request signal T_{req} is then checked by the checking device 6 of the activation unit 4 to determine whether the position controller 5 is in an error state. By evaluating a cumulative deviation variable, which is calculated by the calculation unit 11 of the checking device 6 as a time integral over a control deviation e between the desired steering angle β and actual steering angle α, the checking device 6 determines whether the error state is present. If the error state has not been determined, the selection device 10 of the checking device 6 selects the torque request signal T_{req} as a checked torque request signal PT_{req}. If, on the other hand, the error state has been determined, the selection device 10 of the checking device 6 selects a reference torque signal T_{ref} as a checked torque request signal PT_{req}. The reference torque signal T_{ref} is determined by the checking device 6 by means of a reference controller 7 based at least on the control deviation e. Finally, the checked torque request signal PT_{req} is transmitted to the steering actuator 2.

As shown schematically in FIGS. 2 and 3, the cumulative deviation variable can be calculated with a weighting of the control deviation e with a driving speed v of the vehicle. This enables a continuous lane deviation diagnosis since the control deviation e weighted with the momentary driving speed v represents a measure of the lane deviation caused by the control deviation. The cumulative deviation variable can be calculated, for example, based on a simple vehicle model. It is conceivable to use the cumulative deviation variable as an integral over the control deviation e multiplied by the vehicle speed v. In this way, the cumulative deviation variable obtained is a length that correlates with the actual lane deviation. The speed-dependent calculation of the lane deviation on the basis of the vehicle movement makes it possible to calculate the absolute distance of the vehicle from the desired lane solely on the basis of the control deviation and the driving speed.

The cumulative deviation variable can preferably also be calculated as an integral over the control deviation e multiplied by the square (or a higher power) of the vehicle speed v. This greater weighting of the vehicle speed v can advantageously ensure that lane deviations at higher vehicle speeds are corrected more quickly by early intervention by the checking device 6 in the control.

The control deviation e can, however, also be weighted differently when determining the cumulative deviation variable in order to influence the response behavior of the checking device 6. In this case, the calculated integral can differ from the actual lane deviation and/or can have a non-linear relationship therewith.

The integration time of the time integral can be selected to be of arbitrary length. For example, the amount of deviation can be accumulated for the entire period since a previous switching over of the selection device 10. Alternatively, a sliding integration interval with a selectable duration can be used.

The error state of the position controller 5 is preferably determined when the cumulative deviation variable exceeds a selectable threshold value. The threshold value is particularly preferably selected depending on the driving speed v of the vehicle. As a result, active steering assistants can be tolerated to different degrees at different driving speeds. At high speeds, for example, only the steering intervention of a lane-keeping assistant may be tolerated for a certain period of time, while at low speeds even tolerating the lane deviation caused by a parking assistant may be advantageous.

As illustrated in FIG. 3, a momentary angular velocity ω of the steering actuator 2 is preferably taken into account when determining the reference torque signal T_{ref}. By taking into account the angular velocity ω in the reference controller 7, a damping term can be included in the control, said damping term counteracting rapid changes in the actual setting angle α. This makes it possible to take into account, in the calculation of the reference torque signal T_{ref}, the torque required for the damping of suddenly occurring disturbing forces that change the actual setting angle α.

The position controller 5 preferably has a higher bandwidth than the reference controller 7. Owing to the higher bandwidth of the position controller 5, the control of the steer-by-wire steering system can also regulate higher-frequency interferences in normal operation. In the event that such interferences or incorrect operation of the position controller 5 lead(s) to instability in the control section due to the lane deviations building up, the control via the reference controller 7 with a lower bandwidth falls back to a robust and reliable control with a tolerable control deviation e. It can therefore be sufficient to use a reference controller 7 with a lower performance than the position controller 5.

As shown in FIG. 3, the control deviation e in the reference controller 7 is determined as the difference between the desired steering angle α and actual steering angle β and fed to the calculation unit 11. Within the reference controller 7, the control deviation e is furthermore preferably linearly amplified and summed up with a signal component dependent on the angular velocity ω to determine the reference torque signal T_{ref}. The reference torque signal T_{ref} thus preferably contains one component proportional to the difference in the desired steering angle β and the actual steering angle α and one component dependent on the angular velocity ω of the steering actuator 2.

The reference controller 7 can be adapted in an optimized manner to reduce the control deviation e. For this purpose, for example, the two aforementioned signal components can be weighted with respect to one another in such a way that the control deviations e that occur in certain driving situations are minimized.

After the selection device 10 has switched the checked torque request signal PT_{req} to the reference torque signal T_{ref} provided by the reference controller 7, it can be provided that the reference torque signal T_{ref} is used until the end of the operating phase (i.e., for example, until the ignition is switched off) to activate the steering actuator 2.

Alternatively, the checked torque request signal PT_{req} can be switched again back to the torque request signal T_{req} at a later time.

For example, the selection device 10 can switch back from the reference torque signal T_{ref} to the torque request signal T_{req} as a checked torque request signal PT_{req} after a predetermined period of time has elapsed after the error state has been detected. As an alternative or in addition to this, the selection device 10 can also switch back from the reference torque signal T_{ref} to the torque request signal T_{req} as a checked torque request signal PT_{req} when the reference torque signal T_{ref} and/or the torque request signal T_{req} falls below a predeterminable threshold value. As a result of this condition, the switching back takes place only at times when no or only a slight steering torque is applied, and therefore a particularly safe switching back is made possible without a sudden change in the steering torque.

The switching back can also be dependent on the additional or alternative condition that the cumulative deviation variable falls below a predeterminable second threshold value.

Furthermore, it can be provided that the selection device 10 interpolates the checked torque request signal PT_{req} between the reference torque signal T_{ref} and the torque request signal T_{req} during the switching operations. As a result, a smooth transition can be achieved both when the reference controller 7 intervenes and when switching back to the position controller 5, and therefore the steering intervention can take place unnoticed by the driver.

List of Reference Signs

1 steer-by-wire steering system

2 steering actuator

3 feedback actuator

4 activation unit

5 position controller

6 checking device

7 reference controller

10 selection device

11 calculation unit

α a actual steering angle

β desired steering angle

ω angular velocity

e control deviation

v driving speed

T_{req} torque request signal

T_{ref} reference torque signal

PT_{req} checked torque request signal

T_{L} steering torque

F_{Load} steering load

1.-10. (canceled).

11. A method for controlling a steer-by-wire steering system for a motor vehicle comprising an electronically controllable steering actuator that acts on steered wheels and that detects an actual steering angle of the steered wheels, a feedback actuator that detects a desired steering angle set via a steering wheel, and an activation unit that activates the electronically controllable steering actuator in accordance with the desired steering angle and the actual steering angle with a checked torque request signal, wherein the method comprises:
determining a torque request signal by a position controller of the activation unit based at least on the desired steering angle and the actual steering angle;
checking with a checking device of the activation unit whether there is an error state of the position controller;
selecting the torque request signal as the checked torque request signal with a selection device of the checking device if the error state has not been determined;
selecting a reference torque signal as the checked torque request signal with the selection device of the checking device if the error state has been determined; and
transmitting the checked torque request signal to the steering actuator; and
evaluating a cumulative deviation variable, which is calculated by a calculation unit of the checking device as a time integral over a control deviation between the desired steering angle and the actual steering angle, to enable the checking device to determine whether the error state is present and determine the reference torque signal by way of a reference controller based at least on the control deviation.

12. The method of claim 13 wherein the cumulative deviation variable is calculated by weighting the control deviation with a driving speed of the motor vehicle.

13. The method of claim 13 comprising determining the error state of the position controller when the cumulative deviation variable exceeds a selectable threshold value.

14. The method of claim 13 comprising selecting the selectable threshold value based on a driving speed of the motor vehicle.

15. The method of claim 13 comprising taking into account a momentary angular velocity of the steering actuator when determining the reference torque signal by the reference controller.

16. The method of claim 15 wherein the reference torque signal contains a component proportional to the control deviation and a component dependent on the momentary angular velocity of the steering actuator.

17. The method of claim 13 wherein the selection device switches back from the reference torque signal to the torque request signal as the checked torque request signal after a predetermined period of time has elapsed after the error state has been determined.

18. The method of claim 17 wherein while the selection device is switching, the selection device interpolates the checked torque request signal between the reference torque signal and the torque request signal.

19. The method of claim 13 wherein the selection device switches back from the reference torque signal to the torque request signal as the checked torque request signal after at least one of the reference torque signal or the torque request signal falls below a specifiable threshold value.

20. The method of claim 19 wherein while the selection device is switching, the selection device interpolates the checked torque request signal between the reference torque signal and the torque request signal.

21. A steer-by-wire steering system comprising:
an electronically controllable steering actuator that acts on steered wheels and via which an actual steering angle of the steered wheels is detectable;
a feedback actuator with which a desired steering angle set via a steering wheel is detectable; and
an activation unit for activating the electronically controllable steering actuator according to the desired steering angle and the actual steering angle by way of a checked torque request signal,
wherein the activation unit contains a position controller and a checking device with a selection device, wherein the checking device contains a reference controller and a calculation unit and is configured to perform the method of claim 13.
